(19) United States
(12) Patent Application Publication
(10) Pub. No.: US 2021/0195900 A1
(43) Pub. Date: Jul. 1, 2021

(54) FUNGICIDAL MIXTURES FOR SOYBEAN DISEASES

(71) Applicant: PIONEER HI-BRED INTERNATIONAL, INC., JOHNSTON, IA (US)

(72) Inventors: KEITH A. O'BRYAN, JOHNSTON, IA (US); WARREN RICHARDSON, URBANDALE, IA (US)

(73) Assignee: PIONEER HI-BRED INTERNATIONAL, INC., JOHNSTON, IA (US)

(21) Appl. No.: 17/265,993

(22) PCT Filed: Aug. 13, 2019
(86) PCT No.: PCT/US19/46342

§ 371 Date: Feb. 4, 2021

Related U.S. Application Data
(60) Provisional application No. 62/720,527, filed on Aug. 21, 2018.

(51) Int. Cl. A01N 43/56; A01N 43/40; A01N 63/22

(52) U.S. Cl. CPC A01N 43/56; A01N 63/22; A01N 43/40

(57) ABSTRACT

Disclosed are fungicidal mixtures, compositions and methods for controlling plant diseases relating to combinations comprising non-identical SDHI fungicides/nematicides or an agriculturally suitable salt thereof and derivatives thereof. Fluopyram and derivatives thereof in combination with other SDHI fungicides are provided for controlling soybean cyst nematode (SCN) and sudden death syndrome (SDS) in soybeans. Disclosed are fungicidal mixtures of penthiopyrad and fluopyram and derivatives thereof, for controlling soybean cyst nematode (SCN) and sudden death syndrome (SDS) in soybeans.

This is a national phase entry under 35 U.S.C. § 371 of international patent application PCT/US19/46342, filed on Aug. 13, 2019 and published in English as international patent publication WO2020/041040 on Feb. 27, 2020, which claims priority to the benefit of U.S. Provisional Patent Application Ser. No. 62/720,527 filed Aug. 21, 2018 the disclosure of which is hereby incorporated by reference in its entirety.

### FIELD

This disclosure relates to fungicidal mixtures and to compositions comprising such mixtures and methods for using such mixtures as fungicides.

### BACKGROUND

The control of plant diseases caused by fungal plant pathogens is extremely important in achieving high crop efficiency. Plant disease damage to ornamental, vegetable, field, cereal, and fruit crops can cause significant reduction in productivity and thereby result in increased costs to the consumer. Many products are commercially available for these purposes, but the need continues for new mixtures and compositions that are more effective, less costly, less toxic, environmentally safer or have different modes of action.

Fungicides that effectively control plant fungi are in constant demand by growers. Combinations of fungicides are often used to facilitate disease control and to retard resistance development. It is desirable to enhance the activity spectrum and the efficacy of disease control by using mixtures of active ingredients that provide a combination of curative, systemic and preventative control of plant pathogens. Also desirable are combinations that provide greater residual control to allow for extended spray intervals. It is also very desirable to combine fungicidal agents that inhibit different biochemical pathways in the fungal pathogens to retard development of resistance to any one particular plant disease control agent.

### SUMMARY

A fungicidal mixture includes:

(a) a Pyridinyl-ethyl-benzamide fungicide; and

(b) at least one different Succinate dehydrogenase inhibitor (SDHI) fungicide.

A fungicidal mixture includes:

(a) a pyrazole carboxamide fungicide; and

(b) at least one different Succinate dehydrogenase inhibitor (SDHI) fungicide.

In an embodiment, N-[2-(1,3-dimethylbutyl)-3-thienyl]-1-methyl-3-(trifluoromethyl)-1H-pyrazole-4-carboxamide (including all stereoisomers) or an agriculturally suitable salt thereof and a Pyridinyl-ethyl-benzamide comprise a fungicidally effective mixture. Optionally, the mixture includes agriculturally suitable salts thereof. Fungicidal mixtures disclosed herein also include least one additional component selected from the group consisting of surfactants, solid diluents and liquid diluents.

This disclosure also relates to a method for controlling a plant disease caused by a fungal plant pathogen comprising applying to the plant or portion thereof a fungicidally effective amount of a mixture of the disclosure (e.g., as a composition described herein).

A fungicidal mixture includes:
(a) the thiophene derivative of Formula I or an agriculturally suitable salt thereof

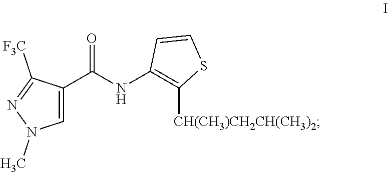

(b) N-{2-[3-Chloro-5-(trifluoromethyl)-2-pyridinyl]ethyl}-2-(trifluoromethyl)benzamide (Formula II); and
wherein weight ratio of the Formula I composition and Formula II composition is from about 10:1 to about 1:2.

In an embodiment, the mixture effectively controls sudden death syndrome in soybeans. In an embodiment, the thiophene derivative of Formula I is penthiopyrad. In an embodiment, mixture includes at least one additional component selected from the group consisting of surfactants, solid diluents and liquid diluents.

A seed coated with the mixture of Formula I and Formula II.

A method of controlling sudden death syndrome (SDS) in soybean, the method includes:

(a) providing a soybean seed treated with a fungicidally effective mixture comprising a first fungicide and a second fungicide, wherein (i) the first fungicide and second fungicides are succinate dehydrogenase inhibitors; (ii) first fungicide is present in a weight ratio of about 10:1 to about 1:2 of the second fungicide; and

(b) growing the soybean seed.

In an embodiment, the first fungicide is a pyrazole carboxamide fungicide. In an embodiment, the second fungicide is a Pyridinyl-ethyl-benzamide fungicide. In an embodiment, the first fungicide is present at a dosage of about 0.14-0.25 mg active ingredient/seed. In an embodiment, the second fungicide is present at a dosage of about 0.075-0.15 mg active ingredient/seed. In an embodiment, the first fungicide is penthiopyrad and the second fungicide is fluopyram.

In an embodiment, the SDS is controlled in the absence of substantial soybean seedling chlorosis as determined at soybean growth stage of VE to V1, when grown in a field displaying moderate to severe pressure from Fusarium virguliforme and when compared to a control soybean seedling grown from a seed treated with either the first or the second fungicide alone.

In an embodiment, the soybean seedling does not exhibit substantial soybean seedling chlorosis as determined at soybean growth stage of VE to V1, when compared to a control soybean seedling grown from a seed treated with the second fungicide alone at a rate of about 0.15 mg active ingredient per seed.

A method of increasing soybean grain yield under pressure from sudden death syndrome (SDS) and/or soybean cyst nematode (SCN), the method comprising growing a soybean seed treated with a fungicidally effective mixture comprising a first fungicide and a second fungicide, wherein (i) the first fungicide and second fungicides are succinate dehydrogenase inhibitors; (ii) first fungicide is present in a weight ratio of about 10:1 to about 1:2 of the second fungicide; and thereby increasing soybean grain yield.

In an embodiment, the first fungicide is a pyrazole carboxamide fungicide.

In an embodiment, the second fungicide is a Pyridinyl-ethyl-benzamide fungicide. In an embodiment, the SDS is controlled in the absence of substantial soybean seedling chlorosis as determined at soybean growth stage of VE to V1, when grown in a field displaying moderate to severe pressure from Fusarium virguliforme and when compared to a control soybean seedling grown from a seed treated with either the first or the second fungicide alone.

In an embodiment, the soybean seedling does not exhibit substantial soybean seedling chlorosis as determined during soybean growth stage of VE to V1, when compared to a control soybean seedling grown from a seed treated with the second fungicide at a rate of about 0.15 mg active ingredient per seed.

In an embodiment, the soybean seedling does not exhibit substantial soybean seedling chlorosis under SDS pressure as determined during soybean growth stage of VE to V1, when compared to a control soybean seedling grown from a seed treated with the first fungicide at a rate of about 0.14-0.25 mg active ingredient per seed or the second fungicide at a rate of about 0.15 mg active ingredient per seed.

In an embodiment, the soybean seedling does not exhibit absence of substantial soybean seedling chlorosis as determined at soybean growth stage of VE to V1, when compared to a control soybean seedling grown from a seed treated with the second fungicide at a rate of about 0.15 mg active ingredient per seed.

A soybean seed coated with a fungicidal mixture comprising penthiopyrad at a concentration of about 0.05-0.50 mg active ingredient per seed and fluopyram at a concentration of about 0.025-0.45 mg active ingredient per seed, wherein the fungicidal mixture is effective in controlling sudden death syndrome (SDS).

In an embodiment, the soybean seed treated with a fungicidal mixture, the penthiopyrad is at a concentration of about 0.14 mg active ingredient per seed and fluopyram at a concentration of about 0.075 mg active ingredient per seed. In an embodiment, the seedling does not exhibit substantial soybean seedling chlorosis under SDS pressure as determined during soybean growth stage of VE to V1, when compared to a control soybean seedling grown from a seed treated with fluopyram at a rate of about 0.15 mg active ingredient per seed.

A soybean seedling grown from the seed of claim 24, wherein the seedling does not exhibit substantial soybean seedling chlorosis under SDS pressure as determined during soybean growth stage of VE to V1, when compared to a control soybean seedling grown from a seed treated with penthiopyrad at a rate of about 0.14-0.25 mg active ingredient per seed.

A method reducing seedling chlorosis or crop response in soybean, the method comprising applying to a soybean seed a fungicidal mixture comprising penthiopyrad at a concentration of 0.25 mg active ingredient per seed and fluopyram at a concentration of about 0.075 mg active ingredient per seed and growing the soybean seed in a field suspected of having pressure from SCN and/or SDS.

A method of pest resistant management in soybeans grown under SDS and/or SCN pressure, the method comprising applying a fungicidal mixture comprising at least two SDHI fungicides wherein the two SDHI fungicides are not both carboxamides and wherein the non-carboxamide fungicide is used at a rate that is less than the full rate at which the non-carboxamide fungicide effectively controls SDS in soybeans.

In an embodiment, the fungicidal mixture comprises fluopyram at a rate of about 0.075-0.15 mg active ingredient per seed and penthiopyrad at a rate of about 0.14-0.25 mg active ingredient per seed.

A method of controlling sudden death syndrome (SDS) in soybean, the method includes providing a soybean seed treated with a fungicidally effective mixture comprising at least a first fungicide and a second fungicide, wherein (i) the first fungicide and second fungicides are non-identical succinate dehydrogenase inhibitors; (ii) first fungicide and the second fungicides are present in an amount wherein the individual amount of the first fungicide or the second fungicide alone is not effective to substantially control SDS; and growing the soybean seed in a field capable of displaying SDS. In an aspect, the first fungicide is a pyrazole carboxamide fungicide. In an aspect, the second fungicide is a pyridinyl-ethyl-benzamide fungicide. In an aspect, the first fungicide is present at a dosage of about 0.14-0.25 mg active ingredient/seed. In an aspect, the second fungicide is present at a dosage of about 0.075-0.15 mg active ingredient/seed. In an aspect, the first fungicide is penthiopyrad and the second fungicide is fluopyram. In an aspect, the SDS is controlled in the absence of substantial soybean seedling chlorosis as determined at soybean growth stage of VE to V1, when grown in a field displaying moderate to severe pressure from Fusarium virguliforme and when compared to a control soybean seedling grown from a seed treated with either the first or the second fungicide alone. In an aspect, the soybean plant does not display substantial chlorosis due to the presence of the first and/or the second fungicides.

Generally, “reduction of chlorosis” means a significant reduction of chlorosis-like symptoms in a plant compared with a control plant that is not treated with the same amount/type of the fungicide(s) described herein. In an aspect, the reduction in chlorosis is measured at the cotyledon stage, or the 2-3 leaf, 3-4 leaf, 4-6 leaf, or preferably during the earlier growth cycle of the plant, e.g., soybean plant. In an aspect, a significant reduction (by 25-50%), compared with the untreated plant (100%), more preferably a significant reduction (by 40-79%), compared with the untreated plant (100%); even more preferably, reduction of chlorosis symptoms is reduced (by 70-100%).

A fungicidal mixture composition includes at least a first fungicide and a second fungicide, wherein (i) the first fungicide and second fungicides are non-identical succinate dehydrogenase inhibitors; (ii) first fungicide and the second fungicides are present in an amount wherein the individual amount of the first fungicide and/or the second fungicide alone is not effective to substantially control SDS and/or SCN in soybeans. In an aspect, the first fungicide or the second fungicide is present in an amount effective to control SDS in soybeans. In an aspect, the first fungicide and the second fungicide is effective to control SDS.

### DETAILED DESCRIPTION

The compound N-[2-(1,3-dimethylbutyl)-3-thienyl]-1-methyl-3-(trifluoromethyl)-1H-pyrazole-4-carboxamide, alternatively named 3-(trifluoromethyl)-1-methyl-N-(2-(4-methylpentan-2-yl)thiophen-3-yl)-1H-pyrazole-4-carboxamide and N-{2-(1,3-dimethylbutyl)-3-thienyl}-3-trifluoromethyl-1-methylpyrazole-4-carboxamide, can be represented by Formula I:

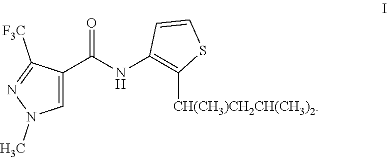

Many compounds in the mixtures of this disclosure (e.g., the compound of Formula I) can exist as one or more stereoisomers. Depending on the compounds, various stereoisomers can include enantiomers, diastereomers, atropisomers and geometric isomers. One skilled in the art will appreciate that one stereoisomer may be more active and/or may exhibit beneficial effects when enriched relative to the other stereoisomer(s) or when separated from the other stereoisomer(s). Additionally, the skilled artisan knows how to separate, enrich, and/or to selectively prepare said stereoisomers. The compounds in the mixtures of this disclosure may be present as a mixture of stereoisomers, individual stereoisomers, or as an optically active form.

Fluopyram and its manufacturing process starting from known and commercially available compounds is described in WO2004016088, incorporated herein by reference. Fungicidal mixtures of thiophene derivatives are discloses in WO2006036827, incorporated herein by reference.

Fluopyram and another SDHI fungicide combinations include, for example in the dose ranges (mg ai/seed) of about (i) fluopyram—0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.30, 0.35, 0.40, 0.45 and 0.50 and (ii) a second SDHI fungicide—0.05, 0.06, 0.07, 0.08, 0.09, 0.10, 0.11, 0.12, 0.13, 0.14, 0.15, 0.16, 0.17, 0.18, 0.19, 0.20, and 0.25. Fluopyram combinations include, for example, in the ratio of weight percentages of non-identical 2^{nd} SDHI fungicide:fluopyram ranging from about 10:1; 5:1; 4:1; 3:1; 2.5:1; 2:1; 1.5:1; 1:1; 1:1.5; and 1:2.

Penthiopyrad and fluopyram combinations include, for example in the dose ranges (mg ai/seed) of about (i) penthiopyrad—0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.30, 0.35, 0.40, 0.45 and 0.50 and (ii) fluopyram—0.05, 0.06, 0.07, 0.08, 0.09, 0.10, 0.11, 0.12, 0.13, 0.14, 0.15, 0.16, 0.17, 0.18, 0.19, 0.20, and 0.25. Penthiopyrad and fluopyram combinations include, for example, in the ratio of weight percentages of penthiopyrad:fluopyram ranging from about 10:1; 5:1; 4:1; 3:1; 2.5:1; 2:1; 1.5:1; 1:1; 1:1.5; and 1:2. Penthiopyrad and Fluopyram mixture compositions disclosed herein are useful in controlling nematodes in corn belonging to at least one species selected from the group of the phytoparasitic nematodes, especially consisting of Belonolaimus longicaudatus, Paratrichodorus minor and also consisting of Pratylenchus brachyurus, Pratylenchus delattrei, Pratylenchus hexincisus, Pratylenchus penetrans, Pratylenchus zeae, (Belonolaimus gracilis), Belonolaimus nortoni, Longidorus breviannulatus, Meloidogyne arenaria, Meloidogyne arenaria thamesi, Meloidogyne graminis, Meloidogyne incognita, Meloidogyne incognita acrita, Meloidogyne javanica, Meloidogyne naasi, Heterodera avenae, Heterodera oryzae, Heterodera zeae, Punctodera chalcoensis, Ditylenchus dipsaci, Hoplolaimus aegyptii, Hoplolaimus magnistylus, Hoplolaimus galeatus, Hoplolaimus indicus, Helicotylenchus digonicus, Helicotylenchus dihystera, Helicotylenchus pseudorobustus, Xiphinema americanum, Dolichodorus heterocephalus, Criconemella ornata, Criconemella onoensis, Radopholus similis, Rotylenchulus borealis, Rotylenchulus parvus, Tylenchorhynchus agri, Tylenchorhynchus clarus, Tylenchorhynchus claytoni, Tylenchorhynchus maximus, Tylenchorhynchus nudus, Tylenchorhynchus vulgaris, Quinisulcius acutus, Paratylenchus minutus, Hemicycliophora parvana, Aglenchus agricola, Anguina tritici, Aphelenchoides arachidis, Scutellonema brachyurum, Subanguina radiciola.

Penthiopyrad and Fluopyram mixture compositions disclosed herein are useful in controlling nematodes in soybean belonging to at least one species selected from the group of the phytoparasitic nematodes, especially consisting of Pratylenchus brachyurus, Pratylenchus pratensis, Pratylenchus penetrans, Pratylenchus scribneri, Belonolaimus longicaudatus, Heterodera glycines, Hoplolaimus columbus and also consisting of Pratylenchus coffeae, Pratylenchus hexincisus, Pratylenchus neglectus, Pratylenchus crenatus, Pratylenchus alleni, Pratylenchus agilis, Pratylenchus zeae, Pratylenchus vulnus, (Belonolaimus gracilis), Meloidogyne arenaria, Meloidogyne incognita, Meloidogyne javanica, Meloidogyne hapla, Hoplolaimus columbus, Hoplolaimus galeatus, Rotylenchulus reniformis.

Agriculturally suitable salts of the compounds in the mixtures of the disclosure include acid-addition salts with inorganic or organic acids such as hydrobromic, hydrochloric, nitric, phosphoric, sulfuric, acetic, butyric, fumaric, lactic, maleic, malonic, oxalic, propionic, salicylic, tartaric, 4-toluenesulfonic or valeric acids. Agriculturally suitable salts of the compounds in the mixtures of the present disclosure also include those formed with organic bases (pyridine, ammonia, or triethylamine) or inorganic bases (hydrides, hydroxides, or carbonates of sodium, potassium, lithium, calcium, magnesium or barium) when the compound contains an acidic group such as a carboxylic acid or phenol.

Embodiments include:

Embodiment 1. A mixture with pyraclostrobin.

Embodiment 2. A mixture with trifloxystrobin.

Embodiment 3. A mixture with ipconazole

Also noteworthy as embodiments are fungicidal compositions of the present disclosure comprising a fungicidally effective amount of a mixture of Embodiments 1 to 4 and at least one additional component selected from the group consisting of surfactants, solid diluents and liquid diluents. Embodiments of the disclosure further include methods for controlling plant diseases caused by fungal plant pathogens comprising applying to the plant or portion thereof, or to the plant seed or seedling, a fungicidally effective amount of a mixture of Embodiments 1 to 4 (e.g., as a composition described herein).

The compound N-[2-(1,3-dimethylbutyl)-3-thienyl]-1-methyl-3-(trifluoromethyl)-1H-pyrazole-4-carboxamide can be prepared by one or more of the methods and variations thereof as described in U.S. Pat. No. 5,747,518 (see e.g., Example 14).

The fungicidal compounds that can be further combined with combinations of the compound of penthiopyrad+fluopyram are commercially available as active ingredients in fungicidal products. These compounds are described in compendia such as The Pesticide Manual, 13th edition, C. D. S. Thomlin (Ed.), British Crop Protection Council, Surrey, U K, 2003. These groups are further described below.

### bc₁ Complex Fungicides

Strobilurin fungicides such as fluoxastrobin, orysastrobin, picoxystrobin, pyraclostrobin and trifloxystrobin are known to have a fungicidal mode of action which inhibits the bc₁ complex in the mitochondrial respiration chain (Angew. Chem. Int. Ed. 1999, 38, 1328-1349). Other strobilurin fungicides suitable for component (b) include (2E)-2-(2-{[6-(3-chloro-2-methylphenoxy)-5-fluor-4-pyrimidinyl]oxy}phenyl)-2-(methoxyimino)-N-methylethanamide, (2E)-2-(methoxyimino)-N-methyl-2-(2-{[({(1E)-1-[3-(trifluoromethyl)phenyl]ethyliden}amino)oxy]methyl}phenyl)ethanamide, (2E)-2-methoxyimino)-N-methyl-2-2-[(E)-({1-[3-(trifluoromethyl)phenyl]ethoxy}imino)methyl] phenyl)ethanamide. Other compounds that inhibit the bc₁ complex in the mitochondrial respiration chain include famoxadone and fenamidone. The bc₁ complex is sometimes referred to by other names in the biochemical literature, including complex III of the electron transfer chain, and ubihydroquinone:cytochrome c oxidoreductase. It is uniquely identified by the Enzyme Commission number EC1.10.2.2. The bc₁ complex is described in, for example, J. Biol. Chem. 1989, 264, 14543-48; Methods Enzymol. 1986, 126, 253-71; and references cited therein.

### Inhibitors of Demethylase in Sterol Biosynthesis

Sterol biosynthesis inhibitors control fungi by inhibiting enzymes in the sterol biosynthesis pathway. Demethylase-inhibiting fungicides have a common site of action within the fungal sterol biosynthesis pathway; that is inhibition of demethylation at position 14 of lanosterol or 24-methylene dihydrolanosterol, which are precursors to sterols in fungi. Compounds acting at this site are often referred to as demethylase inhibitors, DMI fungicides, or DMIs. The demethylase enzyme is sometimes referred to by other names in the biochemical literature, including cytochrome P-450 (14DM). The demethylase enzyme is described in, for example, J. Biol. Chem. 1992, 267, 13175-79 and references cited therein. DMI fungicides fall into several chemical classes: azoles (including triazoles and imidazoles), pyrimidines, piperazines and pyridines. The triazoles include azaconazole, bromuconazole, cyproconazole, difenoconazole, diniconazole (including diniconazole-M), epoxiconazole, etaconazole, fenbuconazole, fluquinconazole, flusilazole, flutriafol, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole and uniconazole. The imidazoles include clotrimazole, econazole, imazalil, isoconazole, miconazole, oxpoconazole, prochloraz and triflumizole. The pyrimidines include fenarimol, nuarimol and triarimol. The piperazines include triforine. The pyridines include buthiobate and pyrifenox. Biochemical investigations have shown that all of the above mentioned fungicides are DMI fungicides as described by K. H. Kuck, et al. in Modern Selective Fungicides—Properties, Applications and Mechanisms of Action, H. Lyr (Ed.), Gustav Fischer Verlag: New York, 1995, 205-258.

Descriptions of the commercially available compounds listed above may be found in The Pesticide Manual, Thirteenth Edition, C. D. S. Tomlin (Ed.), British Crop Protection Council, 2003.

Combinations of fungicides that have different biochemical modes of action are also provided. Such combinations can be particularly advantageous for resistance management, especially where the fungicides of the combination control the same or similar diseases. Combinations of fungicides that provide an expanded spectrum of disease control or enhanced efficacy, including enhanced residual, curative, or preventive control are provided. Examples include combinations of the compound of penthiopyrad+fluopyram combined with one or more strobilurins such as fluoxastrobin, picoxystrobin, pyraclostrobin and trifloxystrobin; and optionally, DMIs such as bromuconazole, cyproconazole, epoxiconazole, fluquinconazole, flusilazole, hexaconazole, metconazole, propiconazole, prothioconazole and tebuconazole.

This disclosure also provides combinations of fungicides that are particularly useful for controlling cereal diseases (e.g., Erisyphe graminis, Septoria nodorum, Septoria tritici, Puccinia recondite and Pyrenophora teres). Examples include combinations of the compound of Formula I with strobilurins such as fluoxastrobin, picoxystrobin, pyraclostrobin and trifloxystrobin; and optionally, DMIs such as bromuconazole, cyproconazole, epoxiconazole, fluquinconazole, flusilazole, hexaconazole, metconazole, propiconazole, prothioconazole and tebuconazole. Of particular note is the use of these combinations for controlling barley diseases (e.g., Pyrenophora teres).

This disclosure also provides combinations of fungicides that are particularly useful for controlling diseases of fruits and vegetables (Alternaria solani, Botrytis cinerea, Rhizoctonia solani, Uncinula necatur). Examples include combinations of the compound of Formula I with strobilurins such as picoxystrobin, pyraclostrobin and trifloxystrobin; and optionally, DMIs such as bromuconazole, cyproconazole, epoxiconazole, fluquinconazole, flusilazole, hexaconazole, metconazole, propiconazole, prothioconazole and tebuconazole.

SDHI fungicides include for example benodanil, benzovindiflupyr, bixafen, boscalid, carboxin, fenfuram, fluopyram, flutolanil, fluxapyroxad, furametpyr, isofetamid, isopyrazam, mepronil, oxycarboxin, penflufen, penthiopyrad, sedaxane and thifluzamide and combinations thereof.

### Formulation/Utility

Mixtures of provided herein will generally be used as a formulation or composition comprising at least one carrier selected from agriculturally suitable liquid diluents, solid diluents and surfactants. A preferred formulation comprising the mixtures disclosed herein is seed treatment or a seed applied coating. The formulation or composition ingredients are selected to be consistent with the physical properties of the active ingredient, mode of application and environmental factors such as soil type, moisture and temperature. Useful formulations include liquids such as solutions (including emulsifiable concentrates), suspensions, emulsions (including microemulsions and/or suspoemulsions) and the like which optionally can be thickened into gels. Useful formulations further include solids such as dusts, powders, granules, pellets, tablets, films, and the like which can be water-dispersible (“wettable”) or water-soluble. The active ingredients can be (micro)encapsulated and further formed into a suspension or solid formulation; alternatively the entire formulation of active ingredient can be encapsulated (or “overcoated”). Encapsulation can control or delay release of the active ingredient. Sprayable formulations can be extended in suitable media and used at spray volumes from about one to several hundred liters per hectare. High-strength compositions are primarily used as intermediates for further formulation.

The formulations will typically contain effective amounts (e.g., from 0.01-99.99 weight percent) of active ingredients together with diluent and/or surfactant within the following approximate ranges which add up to 100 percent by weight.

| | Weight Percent | | |
|---|---|---|---|
| | Active | | |
| | Ingredients | Diluent | Surfactant |
| Water-Dispersible and | 5-90 | 0-94 | 1-15 |
| Water-soluble Granules, | | | |
| Tablets and Powders. | | | |
| Suspensions, Emulsions, | 5-50 | 40-95 | 0-25 |
| Solutions (including | | | |
| Emulsifiable Concentrates) | | | |
| Dusts | 1-25 | 70-99 | 0-5 |
| Granules and Pellets | 0.01-99 | 5-99.99 | 0-15 |
| High Strength Compositions | 90-99 | 0-10 | 0-2 |

Typical solid diluents are described in Watkins, et al., Handbook of Insecticide Dust Diluents and Carriers, 2nd edition, Dorland Books, Caldwell, N.J. Typical liquid diluents are described in Marsden, Solvents Guide, 2nd edition, Interscience, New York, 1950. McCutcheon's Detergents and Emulsifiers Annual, Allured Publ. Corp., Ridgewood, N.J., as well as Sisely and Wood, Encyclopedia of Surface Active Agents, Chemical Publ. Co., Inc., New York, 1964, list surfactants and recommended uses. All formulations can contain minor amounts of additives to reduce foam, caking, corrosion, microbiological growth and the like, or thickeners to increase viscosity.

Surfactants include, for example, polyethoxylated alcohols, polyethoxylated alkylphenols, polyethoxylated sorbitan fatty acid esters, dialkyl sulfosuccinates, alkyl sulfates, alkylbenzene sulfonates, organosilicones, N,N-dialkyltaurates, lignin sulfonates, naphthalene sulfonate formaldehyde condensates, polycarboxylates, and polyoxyethylene/polyoxypropylene block copolymers. Solid diluents include, for example, clays such as bentonite, montmorillonite, attapulgite and kaolin, starch, sugar, silica, talc, diatomaceous earth, urea, calcium carbonate, sodium carbonate and bicarbonate, and sodium sulfate. Liquid diluents include, for example, water, N,N-dimethylformamide, dimethyl sulfoxide, N-alkylpyrrolidone, ethylene glycol, polypropylene glycol, paraffins, alkylbenzenes, alkylnaphthalenes, oils of olive, castor, linseed, tung, sesame, corn, peanut, cotton-seed, soybean, rape-seed and coconut, fatty acid esters, ketones such as cyclohexanone, 2-heptanone, isophorone and 4-hydroxy-4-methyl-2-pentanone, and alcohols such as methanol, cyclohexanol, decanol and tetrahydrofurfuryl alcohol.

Solutions, including emulsifiable concentrates, can be prepared by simply mixing the ingredients. Dusts and powders can be prepared by blending and, usually, grinding as in a hammer mill or fluid-energy mill. Suspensions are usually prepared by wet-milling; see, for example, U.S. Pat. No. 3,060,084. Preferred suspension concentrates include those containing, in addition to the active ingredient, from 5 to 20% nonionic surfactant (for example, polyethoxylated fatty alcohols) optionally combined with 50-65% liquid diluents and up to 5% anionic surfactants. Granules and pellets can be prepared by spraying the active material upon preformed granular carriers or by agglomeration techniques. See Browning, “Agglomeration”, Chemical Engineering, Dec. 4, 1967, pp 147-48, Perry's Chemical Engineer's Handbook, 4th edition, McGraw-Hill, New York, 1963, pages 8-57 and following, and WO 91/13546. Pellets can be prepared as described in U.S. Pat. No. 4,172,714. Water-dispersible and water-soluble granules can be prepared as taught in U.S. Pat. Nos. 4,144,050, 3,920,442 and DE 3,246,493. Tablets can be prepared as taught in U.S. Pat. Nos. 5,180,587, 5,232,701 and 5,208,030. Films can be prepared as taught in GB 2,095,558 and U.S. Pat. No. 3,299,566.

For further information regarding the art of formulation, see U.S. Pat. No. 3,235,361, Col. 6, line 16 through Col. 7, line 19 and Examples 10-41; U.S. Pat. No. 3,309,192, Col. 5, line 43 through Col. 7, line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 1-4; Klingman, Weed Control as a Science, John Wiley and Sons, Inc., New York, 1961, pp 81-96; and Hance et al., Weed Control Handbook, 8th edition, Blackwell Scientific Publications, Oxford, 1989.

In the following Examples, all percentages are by weight and all formulations are prepared in conventional ways. The term “active ingredients” as used in Example A through E refers to the combination of compounds from penthiopyrad and fluopyram, together with any other active ingredient(s) present (e.g., any other fungicide or insecticide). The following Examples are, therefore, to be construed as merely illustrative, and not limiting of the disclosure in any way whatsoever. Percentages are by weight except where otherwise indicated.

### Example A

| Wettable Powder | |
|---|---|
| active ingredients | 65.0% |
| dodecylphenol polyethylene glycol ether | 2.0% |
| sodium ligninsulfonate | 4.0% |
| sodium silicoaluminate | 6.0% |
| montmorillonite (calcined) | 23.0%. |

### Example B

| Emulsifiable Concentrate | |
|---|---|
| active ingredients | 20.0% |
| blend of oil soluble sulfonates | 10.0% |
| and polyoxyethylene ethers | |
| isophorone | 70.0%. |

### Example C

| Suspension Concentrate | |
|---|---|
| active ingredients | 20.0% |
| polyethoxylated fatty alcohol | 15.0% |
| ester derivative of montan wax | 3.0% |
| calcium lignosulfonate | 2.0% |
| polyethoxylated/polypropoxylated | |
| polyglycol block copolymer | 1.0% |
| propylene glycol | 6.4% |
| poly(dimethylsiloxane) | 0.6% |
| antimicrobial agent | 0.1% |
| water | 51.9%. |

Compositions disclosed herein can also include one or more other insecticides, fungicides, nematocides, bactericides, acaricides, growth regulators, chemosterilants, semiochemicals, repellents, attractants, pheromones, feeding stimulants or other biologically active compounds to form a multi-component pesticide giving an even broader spectrum of agricultural protection. Examples of such agricultural protectants with which compositions of this disclosure can be formulated are: insecticides such as abamectin, acephate, azinphos-methyl, bifenthrin, buprofezin, carbofuran, chlorfenapyr, chlorpyrifos, chlorpyrifos-methyl, cyfluthrin, beta-cyfluthrin, cyhalothrin, lambda-cyhalothrin, deltamethrin, diafenthiuron, diazinon, diflubenzuron, dimethoate, esfenvalerate, ethiprole, fenoxycarb, fenpropathrin, fenvalerate, fipronil, flucythrinate, tau-fluvalinate, fonophos, imidacloprid, indoxacarb, isofenphos, malathion, metaldehyde, methamidophos, methidathion, methomyl, methoprene, methoxychlor, monocrotophos, oxamyl, parathion, parathion-methyl, permethrin, phorate, phosalone, phosmet, phosphamidon, pirimicarb, profenofos, rotenone, sulprofos, tebufenozide, tefluthrin, terbufos, tetrachlorvinphos, thiodicarb, tralomethrin, trichlorfon and triflumuron; fungicides besides those listed for component (b) and component (c), such as acibenzolar-S-methyl, benalaxyl (including benalaxyl-M), benthiavalicarb, benomyl, blasticidin-S, Bordeaux mixture (tribasic copper sulfate), boscalid, buthiobate, carpropamid, captafol, captan, carbendazim, chloroneb, chlorothalonil, copper oxychloride, copper salts, cymoxanil, cyazofamid, cyflufenamid, cyprodinil, diclocymet, diclomezine, dicloran, dimethomorph, dodine, edifenphos, ethaboxam, fenhexamid, fenoxanil, fenpiclonil, fenpropidin, fenpropimorph, fentin acetate, fentin hydroxide, fluazinam, fludioxonil, flumorph, flutolanil, folpet, fosetyl-aluminum, furalaxyl, furametapyr, guazatine, hymexazol, iminoctadine, iprobenfos, iprodione, iprovalicarb, isoprothiolane, kasugamycin, mancozeb, maneb, mefenoxam, mepanapyrim, mepronil, metalaxyl, metrafenone, neo-asozin (ferric methanearsonate), oxadixyl, pencycuron, picobenzamid, probenazole, propamocarb, proquinazid, pyrimethanil, pyroquilon, quinoxyfen, silthiofam, spiroxamine, sulfur, thiabendazole, thifluzamide, thiophanate-methyl, thiram, tiadinil, tolylfluanid, validamycin, vinclozolin and zoxamide; nematocides such as aldoxycarb and fenamiphos; bactericides such as streptomycin; acaricides such as amitraz, chinomethionat, chlorobenzilate, cyhexatin, dicofol, dienochlor, etoxazole, fenazaquin, fenbutatin oxide, fenpropathrin, fenpyroximate, hexythiazox, propargite, pyridaben and tebufenpyrad; and biological agents such as Bacillus thuringiensis including ssp. aizawai and kurstaki, Bacillus thuringiensis delta endotoxin, baculovirus, and entomopathogenic bacteria, virus and fungi. Descriptions of various commercially available compounds listed above may be found in The Pesticide Manual, Twelfth Edition, C.D.S. Tomlin, ed., British Crop Protection Council, 2000. For embodiments where one or more of these various mixing partners are used, the weight ratio of these various mixing partners (in total) to the total amount of component (a) and component (b) is typically between 100:1 and 1:3000. Of note are weight ratios between 30:1 and 1:300 (for example ratios between 1:1 and 1:30). It will be evident that including these additional components may expand the spectrum of diseases controlled beyond the spectrum controlled by the combination of component (a), component (b), and the optional component (c) alone.

Of particular note are compositions that can be used with the mixtures provided herein include at least one compound selected from the group consisting of
(d1) alkylenebis(dithiocarbamate) fungicides;
(d2) cymoxanil;
(d3) phenylamide fungicides;
(d4) pyrimidinone fungicides;
(d5) chlorothalonil;
(d6) carboxamides acting at complex II of the fungal mitochondrial respiratory electron transfer site;
(d7) quinoxyfen;
(d8) metrafenone;
(d9) cyflufenamid;
(d10) cyprodinil;
(d11) copper compounds;
(d12) phthalimide fungicides;
(d13) fosetyl-aluminum;
(d14) benzimidazole fungicides;
(d15) cyazofamid;
(d16) fluazinam;
(d17) iprovalicarb;
(d18) propamocarb;
(d19) validomycin;
(d20) dichlorophenyl dicarboximide fungicides;
(d21) zoxamide; and
(d22) dimethomorph;
(d23) non-DMI sterol biosynthesis inhibitors; and
agriculturally suitable salts of compounds of (d1) through (d23).

### Other Fungicide Groups

Alkylenebis(dithiocarbamate)s (d1) include compounds such as mancozeb, maneb, propineb and zineb.

Phenylamides (d3) include compounds such as metalaxyl, benalaxyl, furalaxyl and oxadixyl.

Carboxamides (d6) include compounds such as boscalid, carboxin, fenfuram, flutolanil, furametpyr, mepronil, oxycarboxin and thifluzamide are known to inhibit mitochondrial function by disrupting complex II (succinate dehydrogenase) in the respiratory electron transport chain.

Copper compounds (d11) include compounds such as copper oxychloride, copper sulfate and copper hydroxide, including compositions such as Bordeaux mixture (tribasic copper sulfate).

Phthalimides (d12) include compounds such as folpet and captan.

Benzimidazole fungicides (d14) include benomyl and carbendazim.

Dichlorophenyl dicarboximide fungicides (d20) include chlozolinate, dichlozoline, iprodione, isovaledione, myclozolin, procymidone and vinclozolin.

Non-DMI sterol biosynthesis inhibitors (d23) include morpholine and piperidine fungicides. The morpholines and piperidines are sterol biosynthesis inhibitors that have been shown to inhibit steps in the sterol biosynthesis pathway at a point later than the inhibitions achieved by the DMI sterol biosynthesis (i.e., component (c)). The morpholines include aldimorph, dodemorph, fenpropimorph, tridemorph and trimorphamide. The piperidines include fenpropidin.

The mixtures and compositions disclosed herein are useful as plant disease control agents. The mixtures therefore further comprise a method for controlling plant diseases caused by fungal plant pathogens comprising applying to the plant or portion thereof to be protected, or to the plant seed or seedling to be protected, an effective amount of a mixture of the disclosure or a fungicidal composition containing said mixture.

The mixtures and compositions of this disclosure provide control of diseases caused by a broad spectrum of fungal plant pathogens in the Basidiomycete, Ascomycete, Oomycete and Deuteromycete classes. They are effective in controlling a broad spectrum of plant diseases, particularly foliar pathogens of ornamental, vegetable, field, cereal, and fruit crops. These pathogens include:

Oomycetes, including Phytophthora diseases such as Phytophthora infestans, Phytophthora megasperma, Phytophthora parasitica, Phytophthora cinnamoni and Phytophthora capsici; Pythium diseases such as Pythium aphanidermatum; and diseases in the Peronosporaceae family, such as Plasmopara viticola, Peronospora spp. (including Peronospora tabacina and Peronospora parasitica), Pseudoperonospora spp. (including Pseudoperonospora cubensis), and Bremia lactucae;
Ascomycetes, including Alternaria diseases such as Alternaria solani and Alternaria brassicae; Guignardia diseases such as Guignardia bidwell; Venturia diseases such as Venturia inaequalis; Septoria diseases such as Septoria nodorum and Septoria tritici; powdery mildew diseases such as Erysiphe spp. (including Erysiphe graminis and Erysiphe polygoni), Uncinula necatur, Sphaerotheca fuligena, and Podosphaera leucotricha; Pseudocercosporella herpotrichoides; Botrytis diseases such as Botytis cinerea; Monilinia fructicola; Sclerotinia diseases such as Sclerotinia sclerotiorum; Magnaporthe grisea; Phomopsis viticola; Helminthosporium diseases such as Helminthosporium tritici repentis; Pyrenophora teres; anthracnose diseases such as Glomerella or Colletotrichum spp. (such as Colletotrichum graminicola); and Gaeumannomyces graminis;
Basidiomycetes, including rust diseases caused by Puccinia spp. (such as Puccinia recondita, Puccinia striiformis, Puccinia hordei, Puccinia graminis, and Puccinia arachidis); Hemileia vastatrix; and Phakopsora pachyrhizi;
other pathogens including Rhizoctonia spp (such as Rhizoctonia solani); Fusarium diseases such as Fusarium roseum, Fusarium graminearum and Fusarium oxysporum; Verticillium dahliae; Sclerotium Rynchosporium secalis; Cercosporidium personatum, Cercospora arachidicola and Cercospora beticola;
and other genera and species closely related to these pathogens.

In addition to their fungicidal activity, the mixtures and compositions can also have activity against bacteria such as Erwinia amylovora, Xanthomonas campestris, Pseudomonas syringae, and other related species.

Of note is use of a mixture of this disclosure for controlling Erysiphe graminis (wheat powdery mildew), especially using a mixture wherein component (b) is trifloxystrobin.

Of note is use of a mixture of this disclosure for controlling Septoria nodorum (Septoria glume blotch), especially using a mixture wherein component (b) is trifloxystrobin.

Of note is use of a mixture of this disclosure for controlling Pyrenophora teres (barley net blotch), especially using a mixture wherein component (b) is trifloxystrobin.

Of note is use of a mixture of this disclosure for controlling Puccinia recondita (wheat leaf rust), especially using a mixture wherein component (b) is trifloxystrobin.

Also noteworthy is the use of a mixtures or composition of this disclosure to provide control of diseases caused by a broad spectrum of fungal plant pathogens preventatively or curatively by applying an effective amount of the mixture or composition either pre- or post-infection.

Plant disease control is ordinarily accomplished by applying an effective amount of a mixture of this disclosure either pre- or post-infection, to the portion of the plant to be protected such as the roots, stems, foliage, fruit, seeds, tubers or bulbs, or to the media (soil or sand) in which the plants to be protected are growing. Application of the mixture to a seed can protect both the seed and the seedling grown from the seed. Typically the mixture is applied in the form of a composition comprising at least one additional component selected from the group consisting of surfactants, solid diluents and liquid diluents.

The mixture of this disclosure provides advantageous control of fungal plant diseases when compared to the control achieved by each of the component alone. Mixtures of this disclosure are particularly effective in controlling certain diseases of soybean such as those caused by Heterodera glycines (SCN) and/or Fusarium virguhforme (SDS).

The presence of an unexpected benefit (effect) between two active ingredients can be shown for example, using a representative Colby equation (see S. R. Colby, “Calculating Synergistic and Antagonistic Responses of Herbicide Combinations”, Weeds, 1967, 15, 20-22):

$$p = A + B - [ \frac{A \times B}{100} ]$$

Generally, using the method of Colby, one can establish the beneficial effect conferred by two active ingredients by first calculating the predicted activity, p, of the mixture based on activities of the two components applied alone. In the equation above, A is the fungicidal activity in percentage control of one component applied alone at rate x. The B term is the fungicidal activity in percentage control of the second component applied at rate y. The equation estimates p, the fungicidal activity of the mixture of A at rate x with B at rate y if their effects are strictly additive and no beneficial effect indicative of more than additive effect has occurred.

### EXAMPLES

Test suspensions comprising a single formulated active ingredient are applied to a plant propagation material such as a seed, to demonstrate the control efficacy of the active ingredient individually. To demonstrate the control efficacy of a combination, (a) the active ingredients can be combined in the appropriate amounts in a single test suspension, (b) stock solutions of individual active ingredients can be prepared and then combined in the appropriate ratio, and diluted to the final desired concentration to form a test suspension or (c) test suspensions comprising single active ingredients can be sprayed sequentially in the desired ratio.

The present disclosure is further illustrated in the following Examples, in which parts and percentages are by weight and degrees are Celsius, unless otherwise stated. It should be understood that these examples, while indicating embodiments of the disclosure, are given by way of illustration only. From the above discussion and these Examples, one skilled in the art can ascertain the essential characteristics of this disclosure, and without departing from the spirit and scope thereof, can make various changes and modifications of the disclosure to adapt it to various usages and conditions. Furthermore, various modifications of the disclosure in addition to those shown and described herein will be apparent to those skilled in the art from the foregoing description. Such modifications are also intended to fall within the scope of the appended claims

### Example 1

### Soybean Sudden Death Syndrome and SCN Seed Treatment Evaluation

Soybean seeds treated with penthiopyrad, fluopyram, a combination thereof, at indicated application rates, along with appropriate controls were grown in multiple field locations under a variety of pest pressures including sudden death syndrome (SDS).

TABLE 1
Active ingredient concentration.

| Penthiopyrad | Fluopyram | |
|---|---|---|
| 0.14 mg ai/seed | 0.075 | mg ai/seed |
| 0.25 mg ai/seed | 0.15 | mg ai/seed |

Early crop response (i.e., chlorosis) resulting from applied seed treatments were assessed during VE to V1 stage using the rating scale as described below:

Scale 9: No noticeable injury, no difference, or healthier plants compared to standard treatment.

Scale 8: <50% of seedlings exhibit chlorosis along margins of cotyledons, no chlorosis on unifoliate or trifoliate leaves.

Scale 7: >50% of seedlings exhibit chlorosis along margins of cotyledons, no chlorosis on unifoliate or trifoliate leaves.

Scale 6: <50% of seedlings exhibit chlorosis or necrosis along margins of cotyledons, slight chlorosis but no necrosis on unifoliate or trifoliate leaves.

Scale 5: >50% of seedlings exhibit chlorosis or necrosis along margins of cotyledons, slight chlorosis but no necrosis on unifoliate or trifoliate leaves.

Scale 4: <50% of seedlings exhibit chlorosis, necrosis, or tissue deformation along margins of cotyledons, unifoliate, or trifoliate leaves.

Scale 3: >50% of seedlings exhibit chlorosis, necrosis, or tissue deformation along margins of cotyledons, unifoliate, or trifoliate leaves.

Scale 2: <50% of seedlings exhibit necrosis along margins of cotyledons, unifoliate, or trifoliate leaves.

Scale 1: >50% of seedlings exhibit necrosis along margins of cotyledons, unifoliate, or trifoliate leaves.

Level of tolerance to Fusarium virguliforme (SDS) in soybean varieties based on SDS score was measured in multiple locations across multiple years. SDS score was determined at or during the soybean developmental stage R6.

Scale for assigning tolerance to SDS scores:

Scale 9=clean, no disease

Scale 8=Up to 10% of plants showing mild symptoms (yellow, chlorotic spots)

Scale 7=Up to 20% plants showing mild symptoms

Scale 6=up to 30% plants showing medium symptoms (necrotic spots develop in the chlorotic areas; considered the lowest ‘acceptable’ score)

Scale 5=40% or more of plants showing medium symptoms

Scale 4=50% or more plants showing medium to heavy symptoms

3, 2, or 1=1/3, 2/3, or complete leaf drop, respectively.

For those evaluations shown herein, the Treatment value is greater than or less than CONTROL, and statistically significant at (P-value <0.10).

TABLE 2
Multi-year, multi-location analysis of penthiopyrad combinations with
fluopyram as seed treatment for yield increase in soybeans. Multiple
locations were tested per year and each location had multiple reps
(4 or 8 reps per location). SAS mixed model REML analysis was
performed for statistical comparisons.

| | Multi-year, Multi-loc |
|---|---|
| Seed Treatment | Yield (bu/acre) |
| Penthiopyrad (0.25 mg ai/seed) | 62.6 |
| Fluopyram (0.15 mg ai/seed) | 62.5 |
| Fluopyram (0.075 mg ai/seed) | 62.2 |
| Penthiopyrad (0.25 mg ai/seed) + | 64.6 |
| Fluopyram (0.075 mg ai/seed) | |
| Control | 60.4 |

Table 2 demonstrates that soybean seeding grown from seeds treated with penthiopyrad and fluopyram showed the highest grain yield compared to seeds treated with penthiapyrad or fluopyram alone.

TABLE 3
Multi-year, multi-location analysis of penthiopyrad combinations with
fluopyram as seed treatment for SDS scores in soybeans. Multiple
locations were tested per year and each location had multiple reps
(4 or 8 reps per location). SAS mixed model REML analysis was
performed for statistical comparisons.

| Seed Treatment | SDS Score (1-9) |
|---|---|
| Penthiopyrad (0.25 mg ai/seed) | 6.7 |
| Fluopyram (0.15 mg ai/seed) | 7.2 |
| Fluopyram (0.075 mg ai/seed) | 6.8 |
| Penthiopyrad (0.25 mg ai/seed) + | 7.5 |
| Fluopyram (0.075 mg ai/seed) | |
| Control | 6.1 |

In certain plots, soybean seedlings grown from seeds treated with a combination of fluopyram at the low rate of (0.075 mg ai/seed) and penthiopyrad (0.25 mg ai/seed) exhibited less seedling chlorosis compared to soybean seedlings grown from seeds treated with fluopyram at the high rate of 0.15 mg ai/seed and achieved similar yield increase under a combination of SDS and/or SCN pest pressure. Table 3 demonstrates that soybean seeding grown from seeds treated with penthiopyrad and fluopyram exhibited the highest SDS score compared to seeds treated with penthiapyrad or fluopyram alone.

### Example 2

### Soybean Sudden Death Syndrome and SCN Evaluation of SDHI Seed Treatments

Soybean seeds treated with two or more non-identical SDHI fungicides are evaluated. Two or more non-identical SDHI fungicides are selected for example, from a group of SDHI (benodanil, benzovindiflupyr, bixafen, boscalid, carboxin, fenfuram, fluopyram, flutolanil, fluxapyroxad, furametpyr, isofetamid, isopyrazam, mepronil, oxycarboxin, penflufen, penthiopyrad, sedaxane and thifluzamide) and the dosage is determined based on a desired result e.g., control of SDS and/or SCN.

For example, a particular SDHI fungicide (designated as “first fungicide” herein) if used at a higher rate or the maximum allowed under a registered label for controlling SDS, causes chlorosis or other crop response, then the dosage/rate of such SDHI fungicide is reduced to an effective amount where application of such lowered level does not result in substantial crop response. A second SDHI fungicide is selected such that it is not identical to the “first fungicide” at a rate that does not result in substantial crop response. Similarly, another non-identical SDHI fungicide is selected if desired. The mixture containing two or more non-identical SDHI fungicides are used so that the mixture is effective in controlling e.g., SDS in the absence of a substantial crop response that would have been displayed by the soybean plants if treated at a higher rate of either the first or the second SDHI fungicides. In an embodiment, it was demonstrated that the mixture of penthiopyrad and fluopyram, at indicated application rates, reduced crop response when compared to the higher treatment rates of fluopyram for controlling sudden death syndrome (SDS).

### Example 3

### Non-Identical SDHI Fungicides for Effective Control of SDS in Soybeans with A Substantial Reduction in Early Crop Response

A pesticidal mixture composition effective for controlling soybean SDS in the absence of substantial chlorosis at or before 3-leaf stage or at the cotyledon stage after emergence includes at least two non-identical succinate dehydrogenase inhibitors (SDHI), wherein the first SDHI is fluopyram and is present on a soybean seed at a rate of about 0.075-0.15 mg ai/seed and wherein the second SDHI is non-identical to fluopyram and is present on the soybean seed in an amount that is effective, along with fluopyram, to control SDS in soybean. In an aspect, the second SDHI is not a pyridinyl-ethyl-benzamide fungicide.

In an aspect, the second SDHI pesticide is a non-systemic fungicide or a fungicide that exhibits reduced systemic movement within a soybean plant when applied as a seed treatment.

A method of controlling SDS in soybean plants with a substantial reduction in chlorosis or necrosis as observed at the cotyledon stage, the method includes applying the pesticidal composition described herein as a seed treatment on a soybean seed and growing the soybean seed on a crop growing environment. In an aspect, the soybean plant is exposed to Fusarium virguliforme, e.g., in a field condition. In an aspect, the soybean plants comprise genetic tolerance to SDS. In an aspect, the second SDHI pesticide is a carboxamide fungicide. In an aspect, the soybean seed is treated with strain B. firmus I-1582.

What is claimed is:

1. A fungicidal mixture comprising:
(a) the thiophene derivative of Formula I or an agriculturally suitable salt thereof 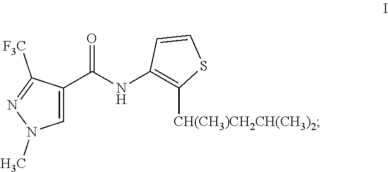
(b)N-{2-[3-Chloro-5-(trifluoromethyl)-2-pyridinyl]ethyl}-2-(trifluoromethyl)benzamide (Formula II); and
wherein weight ratio of the Formula I composition and Formula II composition is from about 10:1 to about 1:2.

2. The mixture of claim 1 wherein the mixture effectively controls sudden death syndrome in soybeans.

3. The mixture of claim 1 wherein the mixture, wherein the thiophene derivative of Formula I is penthiopyrad.

4. The mixture of claim 1 comprising at least one additional component selected from the group consisting of surfactants, solid diluents and liquid diluents.

5. A seed coated with the mixture of claim 1.

6. A method of controlling sudden death syndrome (SDS) in soybean, the method comprising
(a) providing a soybean seed treated with a fungicidally effective mixture comprising a first fungicide and a second fungicide, wherein (i) the first fungicide and second fungicides are non-identical succinate dehydrogenase inhibitors; (ii) first fungicide is present in a weight ratio of about 10:1 to about 1:2 of the second fungicide; and
(b) growing the soybean seed.

7. The method of claim 6, wherein the first fungicide is a pyridinyl-ethyl-benzamide fungicide.

8. The method of claim 6, wherein the first fungicide is a pyrazole carboxamide fungicide.

9. The method of claim 6, wherein the first fungicide is a pyrazole carboxamide and the second fungicide is a pyridinyl-ethyl-benzamide fungicide.

10. The method of claim 6, wherein the first fungicide is present at a dosage of about 0.14-0.25 mg active ingredient/seed.

11. The method of claim 6, wherein the second fungicide is fluopyram and is present at a dosage of about 0.075-0.15 mg active ingredient/seed.

12. The method of claim 6, wherein the first fungicide is penthiopyrad and the second fungicide is fluopyram.

13. The method of claim 6, wherein the SDS is controlled in the absence of substantial soybean seedling chlorosis as determined at soybean growth stage of VE to V1, when grown in a field displaying moderate to severe pressure from Fusarium virguliforme and when compared to a control soybean seedling grown from a seed treated with either the first or the second fungicide alone.

14. The method of claim 6, wherein the soybean seedling does not exhibit substantial soybean seedling chlorosis as determined at soybean growth stage of VE to V1, when compared to a control soybean seedling grown from a seed treated with the second fungicide alone at a rate of about 0.15 mg active ingredient per seed.

15. A method of increasing soybean grain yield under pressure from sudden death syndrome (SDS) and/or soybean cyst nematode (SCN), the method comprising growing a soybean seed treated with a fungicidally effective mixture comprising a first fungicide and a second fungicide, wherein (i) the first fungicide and second fungicides are succinate dehydrogenase inhibitors; (ii) first fungicide is present in a weight ratio of about 10:1 to about 1:2 of the second fungicide; and thereby increasing soybean grain yield.

16. The method of claim 15, wherein the first fungicide is a pyrazole carboxamide fungicide.

17. The method of claim 15, wherein the second fungicide is a Pyridinyl-ethyl-benzamide fungicide.

18. The method of claim 15, wherein the first fungicide is present at a dosage of about 0.14-0.25 mg active ingredient/seed.

19. The method of claim 15, wherein the second fungicide is present at a dosage of about 0.075-0.15 mg active ingredient/seed

20. The method of claim 15, wherein the first fungicide is penthiopyrad and the second fungicide is fluopyram.

21. The method of claim 15, wherein the SDS is controlled in the absence of substantial soybean seedling chlorosis as determined at soybean growth stage of VE to V1, when grown in a field displaying moderate to severe pressure from Fusarium virguliforme and when compared to a control soybean seedling grown from a seed treated with either the first or the second fungicide alone.

22. The method of claim 15, wherein the soybean seedling does not exhibit substantial soybean seedling chlorosis as determined during soybean growth stage of VE to V1, when compared to a control soybean seedling grown from a seed treated with the second fungicide at a rate of about 0.15 mg active ingredient per seed.

23. The method of claim 15, wherein the soybean seedling does not exhibit substantial soybean seedling chlorosis under SDS pressure as determined during soybean growth stage of VE to V1, when compared to a control soybean seedling grown from a seed treated with the first fungicide at a rate of about 0.14-0.25 mg active ingredient per seed or the second fungicide at a rate of about 0.15 mg active ingredient per seed.

24. The method of claim 15, wherein the soybean seedling does not exhibit absence of substantial soybean seedling chlorosis as determined at soybean growth stage of VE to V1, when compared to a control soybean seedling grown from a seed treated with the second fungicide at a rate of about 0.15 mg active ingredient per seed.

25. A soybean seed coated with a fungicidal mixture comprising penthiopyrad at a concentration of about 0.05-0.50 mg active ingredient per seed and fluopyram at a concentration of about 0.025-0.45 mg active ingredient per seed, wherein the fungicidal mixture is effective in controlling sudden death syndrome (SDS).

26. The soybean seed of claim 25, wherein the penthiopyrad is at a concentration of about 0.14 mg active ingredient per seed and fluopyram at a concentration of about 0.075 mg active ingredient per seed.

27. A soybean seedling grown from the seed of claim 25, wherein the seedling does not exhibit substantial soybean seedling chlorosis under SDS pressure as determined during soybean growth stage of VE to V1, when compared to a control soybean seedling grown from a seed treated with fluopyram at a rate of about 0.15 mg active ingredient per seed.

28. A soybean seedling grown from the seed of claim 25, wherein the seedling does not exhibit substantial soybean seedling chlorosis under SDS pressure as determined during soybean growth stage of VE to V1, when compared to a control soybean seedling grown from a seed treated with penthiopyrad at a rate of about 0.14-0.25 mg active ingredient per seed.

29. A method reducing seedling chlorosis or crop response in soybean, the method comprising applying to a soybean seed a fungicidal mixture comprising penthiopyrad at a concentration of 0.25 mg active ingredient per seed and fluopyram at a concentration of about 0.075 mg active ingredient per seed and growing the soybean seed in a field suspected of having pressure from SCN and/or SDS.

30. A method of pest resistant management in soybeans grown under SDS and/or SCN pressure, the method comprising applying a fungicidal mixture comprising at least two SDHI fungicides wherein the two SDHI fungicides are not both carboxamides and wherein the non-carboxamide fungicide is used at a rate that is less than the full rate at which the non-carboxamide fungicide effectively controls SDS in soybeans.

31. The method of claim 30, wherein the fungicidal mixture comprises fluopyram at a rate of about 0.075-0.15 mg active ingredient per seed and penthiopyrad at a rate of about 0.14-0.25 mg active ingredient per seed.

32. A method of controlling sudden death syndrome (SDS) in soybean, the method comprising
(a) providing a soybean seed treated with a fungicidally effective mixture comprising at least a first fungicide and a second fungicide, wherein (i) the first fungicide and second fungicides are non-identical succinate dehydrogenase inhibitors; (ii) first fungicide and the second fungicides are present in an amount wherein the individual amount of the first fungicide or the second fungicide alone is not effective to substantially control SDS; and
(b) growing the soybean seed in a field capable of displaying SDS.

33. The method of claim 32, wherein the first fungicide is a pyrazole carboxamide fungicide.

34. The method of claim 32, wherein the second fungicide is a pyridinyl-ethyl-benzamide fungicide.

35. The method of claim 32, wherein the first fungicide is present at a dosage of about 0.14-0.25 mg active ingredient/seed.

36. The method of claim 32, wherein the second fungicide is present at a dosage of about 0.075-0.15 mg active ingredient/seed.

37. The method of claim 32, wherein the first fungicide is penthiopyrad and the second fungicide is fluopyram.

38. The method of claim 6, wherein the SDS is controlled in the absence of substantial soybean seedling chlorosis as determined at soybean growth stage of VE to V1, when grown in a field displaying moderate to severe pressure from Fusarium virguliforme and when compared to a control soybean seedling grown from a seed treated with either the first or the second fungicide alone.

39. The method of claim 32, wherein the soybean plant does not display substantial chlorosis or crop response due to the presence of the first and/or the second fungicides.

40. A fungicidal mixture composition comprising at least a first fungicide and a second fungicide, wherein (i) the first fungicide and second fungicides are non-identical succinate dehydrogenase inhibitors; (ii) first fungicide and the second fungicides are present in an amount wherein the individual amount of the first fungicide and/or the second fungicide alone is not effective to substantially control SDS and/or SCN in soybeans.

41. The composition of claim 40, wherein either the first fungicide or the second fungicide is present in an amount effective to control SDS in soybeans.

42. The composition of claim 40, wherein the combined amount of the first fungicide and the second fungicide is effective to control SDS.

43. A pesticidal mixture composition comprising at least two non-identical succinate dehydrogenase inhibitors (SDHI) effective for controlling soybean SDS in the absence of substantial chlorosis at or before 3-leaf stage or at the cotyledon stage after emergence, wherein the first SDHI is fluopyram and is present on a soybean seed at a rate of about 0.075-0.15 mg ai/seed and wherein the second SDHI is non-identical to fluopyram and is present on the soybean seed in an amount that is effective, along with fluopyram, to control SDS in soybean.

44. The pesticidal mixture of claim 43, wherein the second SDHI is not a pyridinyl-ethyl-benzamide fungicide.

45. The pesticidal mixture of claim 43, wherein the second SDHI pesticide is a non-systemic fungicide or a fungicide that exhibits reduced systemic movement within a soybean plant when applied as a seed treatment.

46. A method of controlling SDS in soybean plants with a substantial reduction in chlorosis or necrosis as observed at the cotyledon stage, the method comprising applying the pesticidal composition of claim 43 as a seed treatment on a soybean seed and growing the soybean seed on a crop growing environment.

47. The method of claim 46, wherein the soybean plant is exposed to Fusarium virguliforme.

48. The method of claim 46, wherein the soybean plants comprise genetic tolerance to SDS.

49. The method of claim 46, wherein the second SDHI pesticide is a carboxamide fungicide.

50. The method of claim 46, wherein the soybean seed is treated with strain B. firmus I-1582.
